(19) United States
(12) Patent Application Publication
(10) Pub. No.: US 2026/0179191 A1
(43) Pub. Date: Jun. 25, 2026

(54) METHOD AND DEVICE WITH IMAGE RECONSTRUCTION

(71) Applicant: Samsung Electronics Co., Ltd., Suwon-si (KR)

(72) Inventors: Hana LEE, Suwon-si (KR); Insoo KIM, Suwon-si (KR); Hyong Euk LEE, Suwon-si (KR)

(73) Assignee: Samsung Electronics Co., Ltd., Suwon-si (KR)

(21) Appl. No.: 19/226,077

(22) Filed: Jun. 2, 2025

(30) Foreign Application Priority Data
Dec. 24, 2024 (KR) 10-2024-0196133

(51) Int. Cl. G06T 5/60; G06T 5/10; G06T 5/70

(52) U.S. Cl. CPC G06T 5/60; G06T 5/10; G06T 5/70; G06T 2207/20048; G06T 2207/20081; G06T 2207/20084

(57) ABSTRACT

A processor-implemented method includes randomly setting a value of a time step, generating a corrupted training image at the time step by performing intermediate sampling in a frequency domain using a clean training image, a corrupted training image, and the value of the time step, and generating an image reconstruction model configured to reconstruct the corrupted training image at the time step by inputting the corrupted training image at the time step, the clean training image, and the value of the time step to a neural network.

### CROSS-REFERENCE TO RELATED APPLICATIONS

This application claims the benefit under 35 USC § 119(a) of Korean Patent Application No. 10-2024-0196133, filed on Dec. 24, 2024 in the Korean Intellectual Property Office, the entire disclosure of which is incorporated herein by reference for all purposes.

### BACKGROUND

### 1. Field

The following description relates to a method and device with image reconstruction.

### 2. Description of Related Art

A deep learning-based generative model is a technology that generates new data by learning a given data distribution. Representative generative models may include a variational autoencoder (VAE), generative adversarial networks (GANs), and a diffusion model. Specifically, the diffusion model may show the potential to generate high-quality data and may be used in various fields, such as image generation, text-to-image conversion, and three-dimensional (3D) data generation.

The diffusion model may learn a process of gradually converting a data distribution into a noisy state and restoring it. The process may be divided into a forward process and a reverse process and each may have the following characteristics.

The forward process may be a process of converting the original data distribution into a simple distribution (e.g., a Gaussian distribution) by gradually adding Gauss or noise thereto.

The reverse process may be a process of reconstructing the original data from noise using a trained model. The process may be based on Markov chains and probabilistic modeling and the accuracy of the noise removal process may directly affect generated data quality.

A direct diffusion bridge may be an approach introduced to improve a complex sequential noise removal process of a conventional diffusion model. The direct diffusion bridge may be a method of improving the efficiency of a probabilistic sampling process and effectively performing various conditional generations.

A key feature of the direct diffusion bridge may be improved speed by reducing the number of sampling steps compared to the diffusion model.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, a processor-implemented method includes randomly setting a value of a time step, generating a corrupted training image at the time step by performing intermediate sampling in a frequency domain using a clean training image, a corrupted training image, and the value of the time step, and generating an image reconstruction model configured to reconstruct the corrupted training image at the time step by inputting the corrupted training image at the time step, the clean training image, and the value of the time step to a neural network.

The method may include receiving a corrupted image, inputting the corrupted image to the image reconstruction model, generating a reconstructed image by reconstructing the corrupted image input to the image reconstruction model, and generating a corrupted image at a next time step by performing reverse diffusion sampling in the frequency domain using the corrupted image, the reconstructed image, and a value of a next step.

The method may include iteratively performing generating the reconstructed image and generating the corrupted image at the next time step on all time steps sequentially by generating a corrupted image of a next time step by sequentially reducing the time step and inputting the corrupted image at the next time step to the image reconstruction model, and determining a corrupted image at a last time step on which all of the time steps are performed to be a final reconstructed image.

The method may include in response to the final reconstructed image not being a clean image, inputting the final reconstructed image to the image reconstruction model and iteratively performing generating the reconstructed image by sequentially reducing the time step from a beginning and generating the corrupted image at the next time step on all time steps sequentially, and determining a corrupted image at a last time step on which the time steps are all performed to be a final reconstructed image.

The generating of the corrupted training image at the time step by performing intermediate sampling in the frequency domain using the clean training image, the corrupted training image, and the value of the time step may include applying log-Fourier transformation to an intermediate model of a direct diffusion bridge, generating a log-Fourier transformed corrupted training image by applying the clean training image, the corrupted training image, and the value of the time step to a log-Fourier transformed intermediate model, and generating the corrupted training image at the time step by applying reverse log-Fourier transformation to the log-Fourier transformed corrupted training image.

The log-Fourier transformed intermediate model may be implemented by an equation of logF (xₜ)=(1−αₜ) logF (x₀)+aₜ logF (x₁)+σₜz,z˜N(0, I), and F may be Fourier transformation, xₜ may denote a corrupted image at a time step t, x₀ may denote a clean image, which is a target image to be reconstructed, x₁ may denote a corrupted image at a time step 1, aₜ may denote a coefficient that adjusts weights of x₀ and x₁ at the time step t, σₜ may be a coefficient that adjusts a size of noise at the time step t, z may be Gaussian noise of which a mean is 0 and a variance is 1, and N may denote a Gaussian probability distribution.

The generating of the corrupted image at the next time step by performing reverse diffusion sampling on the reconstructed image in the frequency domain may include applying log-Fourier transformation to a reverse diffusion model of the direct diffusion bridge, generating a log-Fourier transformed corrupted image at the next time step by applying the reconstructed image and the value of the next time step to a log-Fourier transformed reverse diffusion model, and generating the corrupted image at the next time step by applying reverse log-Fourier transformation to the log-Fourier transformed corrupted image at the next time step.

The log-Fourier transformed reverse diffusion model may be implemented by an equation of

$$log F ( {x}_{s} ) ← log F ( {\hat{x}}_{0} \vert t ) + ρ {A}^{T} ( y - A log F ( {\hat{x}}_{0} \vert t ) ) + {α}_{s \vert t}^{2} ( log F ( {x}_{s} ) - log F ( {\hat{x}}_{0} \vert t ) ) + {σ}_{s} z ,$$

and F may be Fourier transformation, xₛ may be a sampled corrupted image at a time step s, \hat{x}₀|t may be a clean image estimated by the image reconstruction model at the time step t, ρ may be a hyperparameter for determining a degree of reaction to a residual error between \hat{x}₀|t and the actual measured value y, A^{T} may be a transpose of A, which is a linear measurement matrix

$${α}_{s \vert t}^{2}$$

may be a coefficient that adjusts a ratio between a clean image x₀ and a corrupted image xₜ, σₛ may be a coefficient that adjusts a size of noise at the time step s, and z may be Gaussian noise of which a mean is 0 and a variance is 1.

In one or more general aspects, a non-transitory computer-readable storage medium may store code that, when executed by one or more processors, configures the one or more processors to perform any one, any combination, or all of operations and/or methods disclosed herein.

In one or more general aspects, a processor-implemented method includes receiving a corrupted image, inputting the corrupted image to the image reconstruction model, generating a reconstructed image by reconstructing corrupted image input to the image reconstruction model, and generating a corrupted image at a next time step by performing reverse diffusion sampling on the reconstructed image in a frequency domain.

The method may include iteratively performing generating the reconstructed image and generating the corrupted image at the next time step on all time steps sequentially by generating a corrupted image of a next time step by sequentially reducing the time step and inputting the corrupted image at the next time step to the image reconstruction model, and determining a corrupted image at a last time step on which all of the time steps are performed to be a final reconstructed image.

The method may include receiving a clean training image and a corrupted training image, randomly setting a value of a time step, generating a corrupted training image at the time step by performing intermediate sampling in a frequency domain using the clean training image, the corrupted training image, and the value of the time step, and generating the image reconstruction model configured to reconstruct the corrupted training image at the time step by inputting the corrupted training image at the time step, the clean training image, and the value of the time step to a neural network.

In one or more general aspects, an electronic device includes one or more processors configured to randomly set a value of a time step, generate a corrupted training image at the time step by performing intermediate sampling in a frequency domain using a clean training image, a corrupted training image, and the value of the time step, and generate an image reconstruction model configured to reconstruct the corrupted training image at the time step by inputting the corrupted training image at the time step, the clean training image, and the value of the time step to a neural network.

The one or more processors may be configured to receive a corrupted image, input the corrupted image to the image reconstruction model, generate a reconstructed image by reconstructing the corrupted image input to the image reconstruction model, and generate a corrupted image at a next time step by performing reverse diffusion sampling on the reconstructed image in a frequency domain.

The one or more processors may be configured to iteratively perform generating the reconstructed image and generating the corrupted image at the next time step on all time steps sequentially by generating a corrupted image of a next time step by sequentially reducing the time step and inputting the corrupted image at the next time step to the image reconstruction model, and determine a corrupted image at a last time step on which all of the time steps are performed to be a final reconstructed image.

The one or more processors may be configured to, in response to the final reconstructed image not being a clean image, input the final reconstructed image to the image reconstruction model and iteratively performing generating the reconstructed image by sequentially reducing the time step from a beginning and generating the corrupted image at the next time step on all time steps sequentially, and determine a corrupted image at a last time step on which all of the time steps are performed to be a final reconstructed image.

The one or more processors may be configured to, for the generating of the corrupted training image at the time step by performing intermediate sampling in the frequency domain using the clean training image, the corrupted training image, and the value of the time step, apply log-Fourier transformation to an intermediate model of a direct diffusion bridge, generate a log-Fourier transformed corrupted training image by applying the clean training image, the corrupted training image, and the value of the time step to a log-Fourier transformed intermediate model, and generate the corrupted training image at the time step by applying reverse log-Fourier transformation to the log-Fourier transformed corrupted training image.

The log-Fourier transformed intermediate model may be implemented by an equation of logF (xₜ)=(1−αₜ) logF (x₀)+aₜ logF (x₁)+σₜz,z˜N(0, I), and F may be Fourier transformation, xₜ may denote a corrupted image at a time step t, x₀ may denote a clean image, which is a target image to be reconstructed, x₁ may denote a corrupted image at a time step 1, αₜ may denote a coefficient that adjusts weights of x₀ and x₁ at the time step t, σₜ may be a coefficient that adjusts a size of noise at the time step t, z may be Gaussian noise of which a mean is 0 and a variance is 1, and N may denote a Gaussian probability distribution.

The one or more processors may be configured to, for the generating of the corrupted image at the next time step by performing reverse diffusion sampling on the reconstructed image in the frequency domain, apply log-Fourier transformation to a reverse diffusion model of the direct diffusion bridge, generate a log-Fourier transformed corrupted image at the next time step by applying the reconstructed image and the value of the next time step to a log-Fourier transformed reverse diffusion model, and generate the corrupted image at the next time step by applying reverse log-Fourier transformation to the log-Fourier transformed corrupted image at the next time step.

The log-Fourier transformed reverse diffusion model may be implemented by an equation of

$$log F ( {x}_{s} ) ← log F ( {\hat{x}}_{0} \vert t ) + ρ {A}^{T} ( y - A log F ( {\hat{x}}_{0} \vert t ) ) + {α}_{s \vert t}^{2} ( log F ( {x}_{s} ) - log F ( {\hat{x}}_{0} \vert t ) ) + {σ}_{s} z ,$$

and F may be Fourier transformation, xₛ may be a sampled corrupted image at a time step s, \hat{x}₀|t may be a clean image estimated by the image reconstruction model at the time step t, ρ may be a hyperparameter for determining a degree of reaction to a residual error between \hat{x}₀|t and the actual measured value y, A^{T} may be a transpose of A, which is a linear measurement matrix,

$${α}_{s \vert t}^{2}$$

may be a coefficient that adjusts a ratio between a clean image x₀ and a corrupted image xₜ, σₛ may be a coefficient that adjusts a size of noise at the time step s, and z may be Gaussian noise of which a mean is 0 and a variance is 1.

Other features and aspects will be apparent from the following detailed description, the drawings, and the claims.

### BRIEF DESCRIPTION OF THE DRAWINGS

With regard to the description of the drawings, the same or similar reference numerals may be used to refer to the same or similar components.

FIG. 1 is a diagram illustrating a schematic configuration of a device for reconstructing an image using a direct diffusion bridge according to one or more embodiments.

FIG. 2 is a diagram illustrating components for generating an image reconstruction model in an image reconstruction device according to one or more embodiments.

FIG. 3 is a diagram illustrating components for reconstructing a corrupted image using an image reconstruction model in an image reconstruction device according to one or more embodiments.

FIG. 4 is a flowchart illustrating a process of generating an image reconstruction model in an image reconstruction device according to one or more embodiments.

FIG. 5 is a flowchart illustrating a process of performing intermediate sampling by an image reconstruction device according to one or more embodiments.

FIG. 6 is a flowchart illustrating a process of reconstructing a corrupted image by an image reconstruction device according to one or more embodiments.

FIG. 7 is a flowchart illustrating reverse diffusion sampling by an image reconstruction device according to one or more embodiments.

Throughout the drawings and the detailed description, unless otherwise described or provided, the same drawing reference numerals may be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” to specify the presence of stated features, numbers, operations, members, elements, and/or combinations thereof, other embodiments may exist where one or more of the stated features, numbers, operations, members, elements, and/or combinations thereof are not present.

Unless otherwise defined, all terms including technical and scientific terms used herein have the same meaning as commonly understood by one of ordinary skill in the art to which the present disclosure pertains and after an understanding of the present disclosure. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment,” and “one or more examples” has a same meaning as “in one or more embodiments”).

When describing the embodiments with reference to the accompanying drawings, like reference numerals refer to like constituent elements and a repeated description related thereto will be omitted. In the description of embodiments, detailed description of well-known related structures or functions will be omitted when it is deemed that such description will cause ambiguous interpretation of the present disclosure.

Although terms such as “first,” “second,” and “third,” or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but is used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The same name may be used to describe an element included in the embodiments described above and an element having a common function. Unless otherwise mentioned, the description of one embodiment may be applicable to other embodiments. Thus, duplicated description is omitted for conciseness.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on,” “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

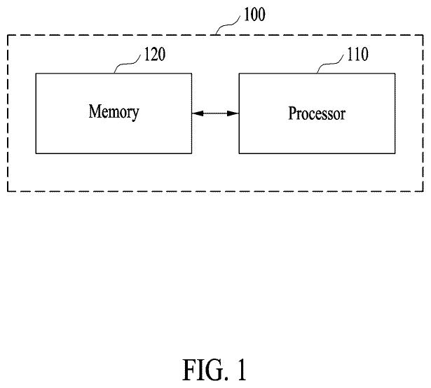

Hereinafter, a method and device for reconstructing an image using a direct diffusion bridge according to one or more embodiments of the present disclosure are described with reference to FIGS. 1 to 7.

FIG. 1 is a diagram illustrating a schematic configuration of a device for reconstructing an image using a direct diffusion bridge according to one or more embodiments.

Referring to FIG. 1, an image reconstruction device 100 may include a processor 110 (e.g., one or more processors) and a memory 120 (e.g., one or more memories). In this case, the image reconstruction device 100 may correspond to an electronic device and the electronic device may include a communication device such as a smartphone, a vehicle such as an automobile, a display device such as a television (TV), a consumer electronic apparatus such as washing machine, and a manufacturing apparatus.

The memory 120 may store an operating system (OS) for controlling the overall operation of the image restoration device 100, an application program, and storage data. Additionally, the memory 120 may store an application program, training data, information on a generated image reconstruction model, and information on accessibility reinforcement such as accessibility information.

The processor 110 may control operations of the image reconstruction device 100 of FIG. 1 by executing instructions stored in the memory 120. For example, the memory 120 may be or include a non-transitory computer-readable storage medium storing code that, when executed by the processor 110, configures the processor 110 to perform any one, any combination, or all of operations and/or methods disclosed herein with reference to FIGS. 1-7.

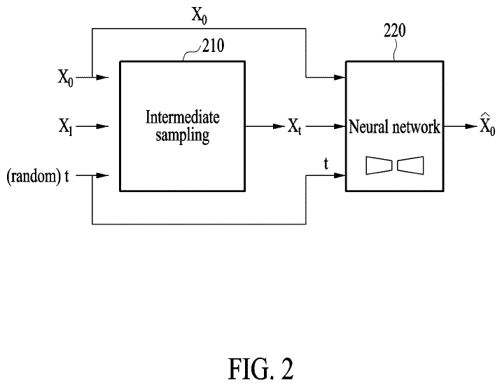

By executing the instructions stored in the memory 120, the processor 110 may generate an image reconstruction model configured to reconstruct a corrupted training image using a clean training image and the corrupted training image, which are training data. An example of a specific training method of generating the image reconstruction model is further described with reference to FIGS. 2, 4, and 5.

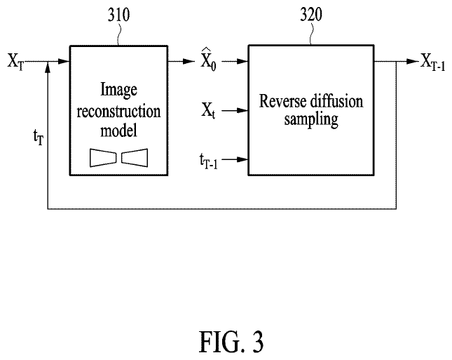

The processor 110 may also reconstruct a corrupted image by reverse diffusion sampling in a frequency domain using the image reconstruction model by executing the instructions stored in the memory 120. An example of a specific training method of reconstructing a corrupted image is further described with reference to FIGS. 3, 6, and 7.

The description of FIG. 1 describes that the image reconstruction device 100 performs both generating an image reconstruction model and reconstructing a corrupted image through training. However, the example is not limited thereto and generating an image reconstruction model and reconstructing a corrupted image through training may be implemented by separate devices.

FIG. 2 is a diagram illustrating components for generating an image reconstruction model in an image reconstruction device according to one or more embodiments.

Referring to FIG. 2, the processor 110 may perform intermediate sampling 210 using training data (e.g., a clean training image x₀, a corrupted training image x₁, and a value t of a time step that is randomly set). In this case, the value of the time step may be between 0 and 1 and when an interval of the time step is set to 0.1, the value of the time step may be one of 0.1, 0.2, 0.3, 0.4, 0.5, 0.6, 0.7, 0.8, and 0.9. The interval of the time step may be determined experimentally or randomly. That the value t of the time step may be set “randomly” may mean the value t of the time step is generated using a random number generator (RNG), where the value t of the time step cannot be reasonably predicted better than by random chance. For example, the RNG may be a hardware RNG (HRNG) which generates the value t of the time step as a function of a current value of a physical environment's attribute that is constantly changing in a manner that is practically impossible to model.

The intermediate sampling 210 may perform sampling by a log-Fourier transformed intermediate model that is generated by applying log-Fourier transformation to an intermediate model of the direct diffusion bridge.

In this case, the intermediate model of the direct diffusion bridge may be expressed by Equation 1 below, for example, and the log-Fourier transformed intermediate model may be expressed by Equation 2 below, for example.

$${x}_{t} = ( 1 - {α}_{t} ) {x}_{0} + {α}_{t} {x}_{1} + {σ}_{t} z , z ∼ N ( 0 , I ) \qquad Equation 1$$

In Equation 1, xₜ may denote a corrupted image at a time step t, x₀ may denote a clean image, which is a target image to be reconstructed, x₁ may denote a corrupted image at a time step 1, αₜ may denote a coefficient that adjusts weights of x₀ and x₁ at the time step t, σₜ may be a coefficient that adjusts the size of noise at the time step t, z may denote Gaussian noise of which a mean is 0 and a variance is 1, and N may denote a Gaussian probability distribution.

$$log F ( {x}_{t} ) = ( 1 - {α}_{t} ) log F ( {x}_{0} ) + {α}_{t} log F ( {x}_{1} ) + {σ}_{t} z , z ∼ N ( 0 , I ) \qquad Equation 2$$

In Equation 2, F may be Fourier transformation, xₜ may denote a corrupted image at the time step t, x₀ may denote a clean image, which is a target image to be reconstructed, x₁ may denote a corrupted image at the time step 1, αₜ may denote a coefficient that adjusts weights of x₀ and x₁ at the time step t, σₜ may be a coefficient that adjusts the size of noise at the time step t, z may denote Gaussian noise of which a mean is 0 and a variance is 1, and N may denote a Gaussian probability distribution.

Further, the processor 110 may generate the image reconstruction model that outputs a clean training image x₀, a corrupted training image xₜ corresponding to the time step t, and a reconstructed training image \hat{x}₀ by inputting the value t of the time step to the neural network 220, and reconstructs the corrupted training image at the time step by performing training by comparing the reconstructed training image \hat{x}₀ with the clean training imagex₀.

By using the direct diffusion bridge that uses a degraded image rather than pure Gaussian noise as an initial sampling state, the method and device of one or more embodiments may perform reconstruction from a state with a specific structure or pattern, and therefore the method and device of one or more embodiments may perform reconstruction faster and more efficient than reconstruction performed from random noise. Further, since the degraded image partially retains the structural information of the original image, the method and device of one or more embodiments may effectively maintain a unique feature of the image using the model.

For a deblurring task, a relation between a degraded image and an original image may be defined using a convolutional operation.

The convolutional operation may be transformed into multiplication in a frequency domain. By performing log transformation thereon, image degradation may be finally represented by an add operation.

Herein, by sampling using the log-Fourier transformed intermediate model to which log-Fourier transformation is applied to the intermediate model of the direct diffusion bridge, the method and device of one or more embodiments may perform more rapid and efficient reconstruction using the diffusion model by directly accessing spectrum by converting a spatial domain into a frequency domain and using it.

FIG. 3 is a diagram illustrating components for reconstructing a corrupted image using an image reconstruction model in an image reconstruction device according to one or more embodiments.

Referring to FIG. 3, the processor 110 may generate a reconstructed image \hat{x}₀ by inputting a corrupted image x_{T} to an image reconstruction model 310. In this case, T may be a maximum value of a time step.

In addition, the processor 110 may generate a next corrupted image x_{T-1} by performing reverse diffusion sampling 320 on the reconstructed image \hat{x}₀, the corrupted image x_{T}, and a value t_{T-1} of a next time step.

In addition, the processor 110 may iteratively perform the image reconstruction model 310 and reverse diffusion sampling 320 until T reaches 0 by inputting the next corrupted image x_{T-1} to the image reconstruction model 310.

The reverse diffusion sampling 320 may perform sampling by a log-Fourier transformed reverse diffusion model obtained by applying log-Fourier transformation to the reverse diffusion model of the direct diffusion bridge.

In this case, the reverse diffusion model of the direct diffusion bridge may be expressed by Equation 3 below, for example, and the log-Fourier transformed reverse diffusion model may be expressed by Equation 4 below, for example.

$${x}_{s} ← {\hat{x}}_{0} \vert t + ρ {A}^{T} ( y - A {\hat{x}}_{0} \vert t ) + {α}_{s \vert t}^{2} ( {x}_{s} - {\hat{x}}_{0} \vert t ) + {σ}_{s} z \qquad Equation 3$$

In Equation 3, xₛ may be a sampled corrupted image at a time steps, \hat{x}₀|t may be a clean image estimated by the image reconstruction model at the time step t, ρ may be a hyperparameter for determining a degree of reaction to a residual error between \hat{x}₀|t and an actual measured value y, A^{T} may be a transpose of A, which is a linear measurement matrix,

$${α}_{s \vert t}^{2}$$

may be a coefficient that adjusts a ratio between the clean image x₀ and the corrupted image xₜ as the time moves from t to s, σₛ may be a coefficient that adjusts the size of noise at the time step s, and z may be Gaussian noise of which the mean is 0 and the variance is 1.

$$log F ( {x}_{s} ) ← log F ( {\hat{x}}_{0} \vert t ) + ρ {A}^{T} ( y - A log F ( {\hat{x}}_{0} \vert t ) ) + {α}_{s \vert t}^{2} ( log F ( {x}_{s} ) - log F ( {\hat{x}}_{0} \vert t ) ) + {σ}_{s} z \qquad Equation 4$$

In Equation 4, F is Fourier transformation, xₛ may be a sampled corrupted image at the time step s, \hat{x}₀|t may be a clean image estimated by the image reconstruction model at the time step t, ρ may be a hyperparameter for determining a degree of reaction to a residual error between \hat{x}₀|t and the actual measured value y, A^{T} may be a transpose of A, which is a linear measurement matrix,

$${α}_{s \vert t}^{2}$$

may be a coefficient that adjusts a ratio between the clean image x₀ and the corrupted image xₜ, σₛ may be a coefficient that adjusts the size of noise at the time step s, and z may be Gaussian noise of which the mean is 0 and the variance is 1.

Hereinafter, an example of a method according to the present disclosure configured as described above is described below with reference to the drawings.

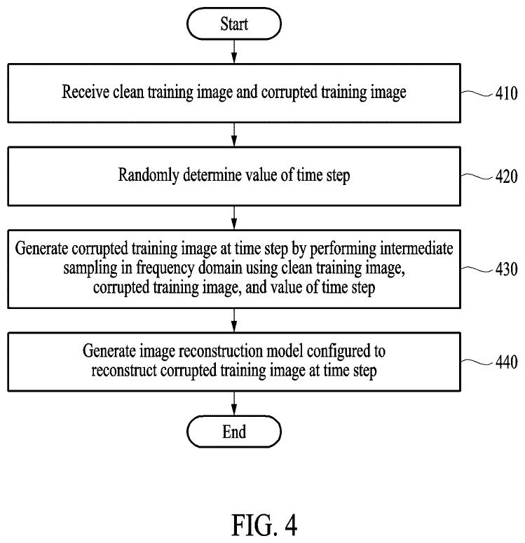

FIG. 4 is a flowchart illustrating a process of generating an image reconstruction model in an image reconstruction device according to one or more embodiments. Operations 410 to 440 of FIG. 4 may be performed in the order and manner shown. However, the order of one or more of the operations may be changed, one or more of the operations may be omitted, two or more of the operations may be performed in parallel or simultaneously, and/or other operations may be additionally performed without departing from the spirit and scope of the example embodiments described herein.

Referring to FIG. 4, in operation 410, the image reconstruction device 100 may receive a clean training image and a corrupted training image, which are training data, for training.

In operation 420, the image reconstruction device 100 may randomly set a value of a time step. In this case, the value of the time step may be between 0 and 1 and when an interval of the time step is set to 0.1, the value of the time step may be one of 0.1, 0.2, 0.3, 0.4, 0.5, 0.6, 0.7, 0.8, and 0.9. The interval of the time step may be determined experimentally or randomly.

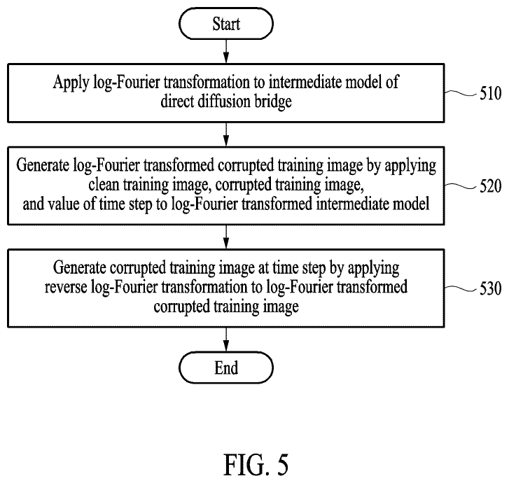

In operation 430, the image reconstruction device 100 may generate a corrupted training image at the time step by performing intermediate sampling in a frequency domain using the clean training image, the corrupted training image, and the value of the time step. An example of operation 430 is further described with reference to FIG. 5.

In operation 440, the image reconstruction device 100 may generate an image reconstruction model that reconstructs the corrupted training image at the time step.

FIG. 5 is a flowchart illustrating a process of performing intermediate sampling by an image reconstruction device according to one or more embodiments. Operations 510 to 530 of FIG. 5 may be performed in the order and manner shown. However, the order of one or more of the operations may be changed, one or more of the operations may be omitted, two or more of the operations may be performed in parallel or simultaneously, and/or other operations may be additionally performed without departing from the spirit and scope of the example embodiments described herein.

Referring to FIG. 5, in operation 510, the image reconstruction device 100 may apply log-Fourier transformation to an intermediate model of a direct diffusion bridge. The intermediate model of the direct diffusion bridge in operation 510 may be expressed by Equation 1 described above and the log-Fourier transformed intermediate model may be expressed by Equation 2 described above.

In operation 520, the image reconstruction device 100 may generate a log-Fourier transformed corrupted training image by applying the clean training image, the corrupted training image, and the value of the time step to the log-Fourier transformed intermediate model.

In operation 530, the image reconstruction device 100 may generate the corrupted training image of the time step by applying reverse log-Fourier transformation to the log-Fourier transformed corrupted training image.

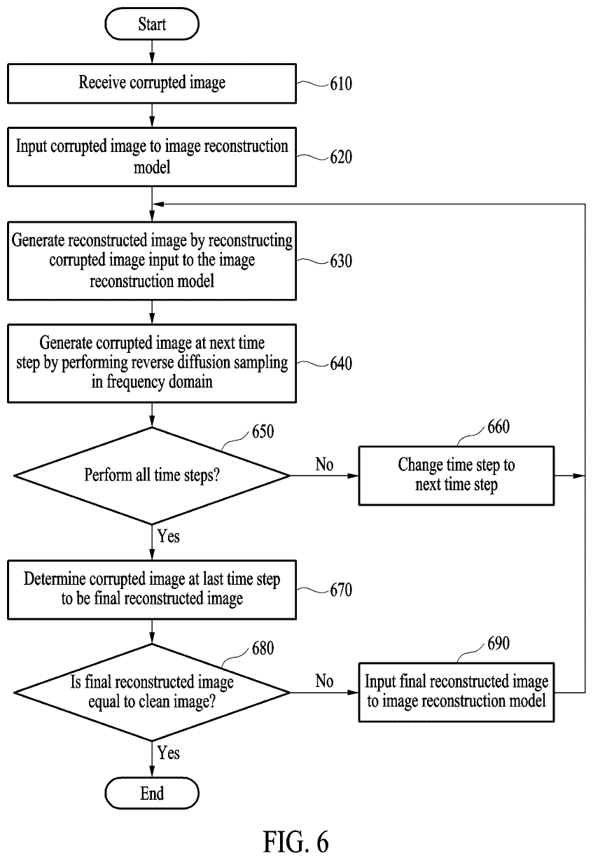

FIG. 6 is a flowchart illustrating a process of reconstructing a corrupted image by an image reconstruction device according to one or more embodiments. Operations 610 to 690 of FIG. 6 may be performed in the order and manner shown. However, the order of one or more of the operations may be changed, one or more of the operations may be omitted, two or more of the operations may be performed in parallel or simultaneously, and/or other operations may be additionally performed without departing from the spirit and scope of the example embodiments described herein.

Referring to FIG. 6, in operation 610, the image reconstruction device 100 may receive a corrupted image.

In operation 620, the image reconstruction device 100 may input the corrupted image to the image reconstruction model.

In operation 630, the image reconstruction device 100 may generate a reconstructed image by reconstructing the corrupted image input to the image reconstruction model.

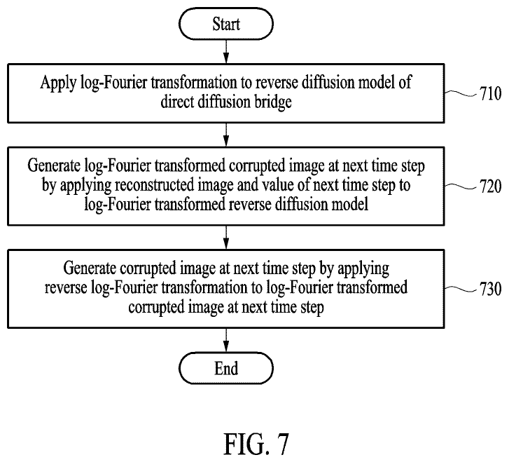

In operation 640, the image reconstruction device 100 may generate a corrupted image of a next time step by performing reverse diffusion sampling in the frequency domain. An example of operation 640 is further described with reference to FIG. 7.

In operation 650, the image reconstruction device 100 may determine whether all times steps are performed on all time steps.

As a result of determination in operation 650, when all time steps are not performed on all time steps, in operation 660, the image reconstruction device 100 may change the time step to the next time step and may return to operation 630.

As a result of determination in operation 650, when all time steps are performed on all time steps, in operation 670, the image reconstruction device 100 may determine a corrupted image of a last time step to be a final reconstructed image.

In operation 680, the image reconstruction device 100 may determine whether the final reconstructed image is a clean image. In other words, the image reconstruction device 100 may determine whether the image construction is sufficiently completed.

As a result of determination in operation 680, when the final reconstructed image is not a clean image, in operation 690, the image reconstruction device 100 may input the final reconstructed image to the image reconstruction model and may return to operation 630.

As a result of determination in operation 680, when the final reconstructed image is a clean image, the image reconstruction device 100 may terminate the algorithm of FIG. 6.

FIG. 7 is a flowchart illustrating reverse diffusion sampling by an image reconstruction device according to one or more embodiments. Operations 710 to 730 of FIG. 7 may be performed in the order and manner shown. However, the order of one or more of the operations may be changed, one or more of the operations may be omitted, two or more of the operations may be performed in parallel or simultaneously, and/or other operations may be additionally performed without departing from the spirit and scope of the example embodiments described herein.

Referring to FIG. 7, in operation 710, the image reconstruction device 100 may apply log-Fourier transformation to a reverse diffusion model of a direct diffusion bridge.

The reverse diffusion model of the direct diffusion bridge may be expressed by Equation 3 described above and the log-Fourier transformed reverse diffusion model may be expressed by Equation 4 described above.

In operation 720, the image reconstruction device 100 may generate a log-Fourier transformed corrupted image at a next time step by applying a reconstructed image and a value of the next time step to the log-Fourier transformed reverse diffusion model.

In operation 730, the image reconstruction device 100 may generate the corrupted image at the next time step by applying the log-Fourier transformation to the log-Fourier transformed corrupted image of the next time step.

As a result of comparing the image reconstruction method using a direct diffusion bridge in a frequency domain and the conventional image reconstruction method using a direct diffusion bridge, it is identified that the number of repetitions for reconstructing a corrupted image is relatively reduced.

The image reconstruction devices, processors, memories, image reconstruction device 100, processor 110, and memory 120 described herein, including descriptions with respect to respect to FIGS. 1-7, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in, and discussed with respect to, FIGS. 1-7 that perform the operations described in this application are performed by computing hardware, for example, by one or more processors or computers, implemented as described above implementing instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method comprising:
randomly setting a value of a time step;
generating a corrupted training image at the time step by performing intermediate sampling in a frequency domain using a clean training image, a corrupted training image, and the value of the time step; and
generating an image reconstruction model configured to reconstruct the corrupted training image at the time step by inputting the corrupted training image at the time step, the clean training image, and the value of the time step to a neural network.

2. The method of claim 1, further comprising:
receiving a corrupted image;
inputting the corrupted image to the image reconstruction model;
generating a reconstructed image by reconstructing the corrupted image input to the image reconstruction model; and
generating a corrupted image at a next time step by performing reverse diffusion sampling in the frequency domain using the corrupted image, the reconstructed image, and a value of a next step.

3. The method of claim 2, further comprising:
iteratively performing generating the reconstructed image and generating the corrupted image at the next time step on all time steps sequentially by generating a corrupted image of a next time step by sequentially reducing the time step and inputting the corrupted image at the next time step to the image reconstruction model; and
determining a corrupted image at a last time step on which all of the time steps are performed to be a final reconstructed image.

4. The method of claim 3, further comprising:
in response to the final reconstructed image not being a clean image, inputting the final reconstructed image to the image reconstruction model and iteratively performing generating the reconstructed image by sequentially reducing the time step from a beginning and generating the corrupted image at the next time step on all time steps sequentially; and
determining a corrupted image at a last time step on which the time steps are all performed to be a final reconstructed image.

5. The method of claim 1, wherein the generating of the corrupted training image at the time step by performing intermediate sampling in the frequency domain using the clean training image, the corrupted training image, and the value of the time step comprises:
applying log-Fourier transformation to an intermediate model of a direct diffusion bridge;
generating a log-Fourier transformed corrupted training image by applying the clean training image, the corrupted training image, and the value of the time step to a log-Fourier transformed intermediate model; and
generating the corrupted training image at the time step by applying reverse log-Fourier transformation to the log-Fourier transformed corrupted training image.

6. The method of claim 5, wherein
the log-Fourier transformed intermediate model is implemented by an equation of logF (xₜ)=(1−αₜ) logF (x₀)+αₜ logF (x₁)+σₜz,z˜N(0, I), and
F is Fourier transformation, xₜ denotes a corrupted image at a time step t, x₀ denotes a clean image, which is a target image to be reconstructed, x₁ denotes a corrupted image at a time step 1, αₜ denotes a coefficient that adjusts weights of x₀ and x₁ at the time step t, σₜ is a coefficient that adjusts a size of noise at the time step t, z is Gaussian noise of which a mean is 0 and a variance is 1, and N denotes a Gaussian probability distribution.

7. The method of claim 2, wherein the generating of the corrupted image at the next time step by performing reverse diffusion sampling on the reconstructed image in the frequency domain comprises:
applying log-Fourier transformation to a reverse diffusion model of the direct diffusion bridge;
generating a log-Fourier transformed corrupted image at the next time step by applying the reconstructed image and the value of the next time step to a log-Fourier transformed reverse diffusion model; and
generating the corrupted image at the next time step by applying reverse log-Fourier transformation to the log-Fourier transformed corrupted image at the next time step.

8. The method of claim 7, wherein
the log-Fourier transformed reverse diffusion model is implemented by an equation of
$$log F ( {x}_{s} ) ← log F ( {\hat{x}}_{0} \vert t ) + ρ {A}^{T} ( y - A log F ( {\hat{x}}_{0} \vert t ) ) + {α}_{s \vert t}^{2} ( log F ( {x}_{s} ) - log F ( {\hat{x}}_{0} \vert t ) ) + {σ}_{s} z ,$$
and
F is Fourier transformation, xₛ is a sampled corrupted image at a time step s, \hat{x}₀|t is a clean image estimated by the image reconstruction model at the time step t, ρ is a hyperparameter for determining a degree of reaction to a residual error between \hat{x}₀|t and the actual measured value y, A^{T} is a transpose of A, which is a linear measurement matrix,
$${α}_{s \vert t}^{2}$$
is a coefficient that adjusts a ratio between a clean image x₀ and a corrupted image xₜ, σₛ is a coefficient that adjusts a size of noise at the time step s, and z is Gaussian noise of which a mean is 0 and a variance is 1.

9. A non-transitory computer-readable storage medium storing code that, when executed by one or more processors, configures the one or more processors to perform the method of claim 1.

10. A processor-implemented method comprising:
receiving a corrupted image;
inputting the corrupted image to the image reconstruction model;
generating a reconstructed image by reconstructing corrupted image input to the image reconstruction model; and
generating a corrupted image at a next time step by performing reverse diffusion sampling on the reconstructed image in a frequency domain.

11. The method of claim 10, further comprising:
iteratively performing generating the reconstructed image and generating the corrupted image at the next time step on all time steps sequentially by generating a corrupted image of a next time step by sequentially reducing the time step and inputting the corrupted image at the next time step to the image reconstruction model; and
determining a corrupted image at a last time step on which all of the time steps are performed to be a final reconstructed image.

12. The method of claim 10, further comprising:
receiving a clean training image and a corrupted training image;
randomly setting a value of a time step;
generating a corrupted training image at the time step by performing intermediate sampling in a frequency domain using the clean training image, the corrupted training image, and the value of the time step; and
generating the image reconstruction model configured to reconstruct the corrupted training image at the time step by inputting the corrupted training image at the time step, the clean training image, and the value of the time step to a neural network.

13. An electronic device comprising:
one or more processors configured to:
randomly set a value of a time step;
generate a corrupted training image at the time step by performing intermediate sampling in a frequency domain using a clean training image, a corrupted training image, and the value of the time step; and
generate an image reconstruction model configured to reconstruct the corrupted training image at the time step by inputting the corrupted training image at the time step, the clean training image, and the value of the time step to a neural network.

14. The electronic device of claim 13, wherein the one or more processors are configured to:
receive a corrupted image;
input the corrupted image to the image reconstruction model;
generate a reconstructed image by reconstructing the corrupted image input to the image reconstruction model; and
generate a corrupted image at a next time step by performing reverse diffusion sampling on the reconstructed image in a frequency domain.

15. The electronic device of claim 14, wherein the one or more processors are configured to:
iteratively perform generating the reconstructed image and generating the corrupted image at the next time step on all time steps sequentially by generating a corrupted image of a next time step by sequentially reducing the time step and inputting the corrupted image at the next time step to the image reconstruction model; and
determine a corrupted image at a last time step on which all of the time steps are performed to be a final reconstructed image.

16. The electronic device of claim 15, wherein the one or more processors are configured to:
in response to the final reconstructed image not being a clean image, input the final reconstructed image to the image reconstruction model and iteratively performing generating the reconstructed image by sequentially reducing the time step from a beginning and generating the corrupted image at the next time step on all time steps sequentially; and
determine a corrupted image at a last time step on which all of the time steps are performed to be a final reconstructed image.

17. The electronic device of claim 13, wherein the one or more processors are configured to, for the generating of the corrupted training image at the time step by performing intermediate sampling in the frequency domain using the clean training image, the corrupted training image, and the value of the time step:
apply log-Fourier transformation to an intermediate model of a direct diffusion bridge;
generate a log-Fourier transformed corrupted training image by applying the clean training image, the corrupted training image, and the value of the time step to a log-Fourier transformed intermediate model; and
generate the corrupted training image at the time step by applying reverse log-Fourier transformation to the log-Fourier transformed corrupted training image.

18. The electronic device of claim 17, wherein
the log-Fourier transformed intermediate model is implemented by an equation of logF (xₜ)=(1−αₜ) logF (x₀)+αₜ logF (x₁)+σₜz,z˜N(0, I), and
F is Fourier transformation, xₜ denotes a corrupted image at a time step t, x₀ denotes a clean image, which is a target image to be reconstructed, x₁ denotes a corrupted image at a time step 1, αₜ denotes a coefficient that adjusts weights of x₀ and x₁ at the time step t, σₜ is a coefficient that adjusts a size of noise at the time step t, z is Gaussian noise of which a mean is 0 and a variance is 1, and N denotes a Gaussian probability distribution.

19. The electronic device of claim 14, wherein the one or more processors are configured to, for the generating of the corrupted image at the next time step by performing reverse diffusion sampling on the reconstructed image in the frequency domain:
apply log-Fourier transformation to a reverse diffusion model of the direct diffusion bridge;
generate a log-Fourier transformed corrupted image at the next time step by applying the reconstructed image and the value of the next time step to a log-Fourier transformed reverse diffusion model; and
generate the corrupted image at the next time step by applying reverse log-Fourier transformation to the log-Fourier transformed corrupted image at the next time step.

20. The electronic device of claim 19, wherein
the log-Fourier transformed reverse diffusion model is implemented by an equation of
$$log F ( {x}_{s} ) ← log F ( {\hat{x}}_{0} \vert t ) + ρ {A}^{T} ( y - A log F ( {\hat{x}}_{0} \vert t ) ) + {α}_{s \vert t}^{2} ( log F ( {x}_{s} ) - log F ( {\hat{x}}_{0} \vert t ) ) + {σ}_{s} z ,$$
and
F is Fourier transformation, xₛ is a sampled corrupted image at a time step s, \hat{x}₀|t is a clean image estimated by the image reconstruction model at the time step t, ρ is a hyperparameter for determining a degree of reaction to a residual error between \hat{x}₀|t and the actual measured value y, A^{T} is a transpose of A, which is a linear measurement matrix,
$${α}_{s \vert t}^{2}$$
is a coefficient that adjusts a ratio between a clean image x₀ and a corrupted image xₜ, σₛ is a coefficient that adjusts a size of noise at the time step s, and z is Gaussian noise of which a mean is 0 and a variance is 1.
